(19) United States
(12) Patent Application Publication
(10) Pub. No.: US 2005/0055112 A1
(43) Pub. Date: Mar. 10, 2005

(54) Illustration system for machine operation

(75) Inventor: Tung Choi Cheng, Markham (CA)

Correspondence Address: CYM GRAPHICS INC., 1271 DENISON ST., UNIT 47, MARKHAM, ON, L3R 4B5, CA

(73) Assignee: Cym Graphics Inc., Markham (CA)

(21) Appl. No.: 10/657,267

(22) Filed: Sep. 9, 2003

(51) Int. Cl. G06F 19/00

(52) U.S. Cl. 700/83

(57) ABSTRACT

An illustration system has an image device that continually transmits images of a computer-controlled machine in operation to an image capturing software to a machine computer for monitoring purposes. The image capturing software is integrated on the navigator software. The image can be captured in the image capturing software then dragged and dropped to the navigator software to support users' programmed jobs, from the setting up to the finished product. The navigator software provides the user the ability to program a list of job events that is capable of processing on the machine computer to control the machine automation operation. A server interface connects to the navigator software that provides a remote control function via a network to monitor and machine operation control.

### REFERENCES CITED

### U.S. Patent Documents

| | | | |
|---|---|---|---|
| 5550646 | 8/1996 | Hassan et al | 358/442. |
| 5956253 | 9/1999 | Gottschalk | 364/474. |
| 6101425 | 8/2000 | Govindaraj et al | 700/181. |
| 6112133 | 8/2000 | Fishman | 700/182. |
| 6122409 | 9/2000 | Boggs et al | 382/276. |
| 6144895 | 11/2000 | Govindaraj et al | 700/181. |
| 6338003 | 1/2002 | Kamiguchi et al | 700/169. |
| 6434439 | 8/2002 | Raffoni | 700/95. |
| 6470377 | 10/2002 | Sevcik et al | 709/201. |
| 6539313 | 3/2003 | Bornemann et al | 702/33. |
| 6597392 | 7/2003 | Jenkins et al | 348/207. |

### BACKGROUND OF THE INVENTION

The present invention relates to a work process that runs on a computer-controlled machine: the use of an image device, interfaces and a control system for monitoring a work procedure; capturing images and controlling a machine operation with a machine computer or a server computer that remotely controls one or multiple machine computers via a network.

Automation is a widely engaging aspect in the manufacturing industry. A machine that is computer controlled and is able to have its operation of programmed job into the computer will increase productivity. However, this does not provide the solution of fully reducing the operation cost because an experienced operator is still needed to operate the machine. For example, every operation is required to be set up. The placement of the work piece and tools can be unique for each operation, which will require beforehand experience and knowledge. Furthermore, adjustment and maintenance during the operation is required which cannot be replaced simply by a pre-programmed operation.

Another scenario would be an operation that is frequently repeated will be quicker to perform because the set-up time is minimized. However, if the operation is performed occasionally, it would seem like a new job of each time and thus unable to reduce any time efficiency.

### BRIEF SUMMARY OF THE INVENTION

The object of the invention is to provide an illustration along with programmed job on the computer-controlled machine to overcome the aforementioned problems.

Further, it is the object of the invention to provide an accurate and efficient method to standardize the process of each product.

Furthermore, it is the object of the invention to provide a server computer to monitor and remotely control the work procedure and control the machine operation via a network.

Illustrations may include set-up guidelines, position of the work piece and tools, tooling preparation or any adjustment between processes that can be recorded by capturing the image then combining it with the programmed job for an operator to follow step by step.

In accordance with our invention, an illustration system includes an image device that continually transmits images of a machining operation to an image capturing software. The image device is a digital camera that is capable of transmitting pixel data to the machine computer. The image capturing software is a GUI (graphic user interface) that has two image containers. The first image container is for receiving the pixel data from the image device then displaying the image; the second container is capable of displaying a captured image from the first image container when the snap button is clicked.

The image capturing software is integrated on the navigator software. The captured image is displayed on the second image container that can be dragged and dropped to the image container of the navigator software. The captured image can be stored and saved as a part of the programmed job content. The navigator software means a GUI (graphic user interface) that is capable of receiving signals from control system, outputting commands to the motor movement control and also provides the user the ability to program a job process for production.

Control system means a device contain MCUs (micro control units) and a PLD (programmable logic device) for communication between the machine computer and the computer-controlled machine operation. The device contain at least a pair of MCUs for receiving position signals from the measuring device and transmitting and outputting the value to control one of the axis' motor movement. The PLD organizes all inputting and outputting signals and commands from/to the MCUs, the machine and the machine computer. One axis means one direction either of longitude, latitude or altitude of the machine movement.

The server computer contain a server interface capable to monitor and control one or multiple machine operations through one or multiple machine computer via network.

### BRIEF DESCRIPTION OF THE DRAWINGS

Embodiments of the invention will now be described by way of examples only and with reference to the accompanying drawings wherein:

FIG. 1 is a schematic diagram of the illustration system install on a machine operation;

FIG. 2 is a window of the Program/Run Navigator;

FIG. 3 is a window of the Image Capturing;

FIG. 4 is a window of the Select Picture;

FIG. 5 is a flow chart of the operation of signal machine computer and server computer.

### DETAILED DESCRIPTION OF A PERFERRED EMBODIMENT

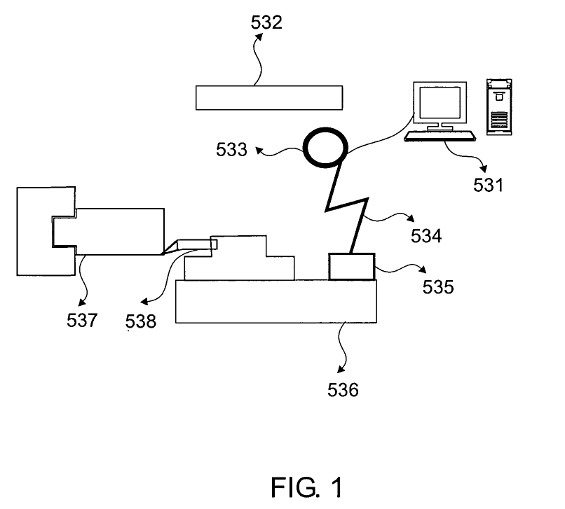

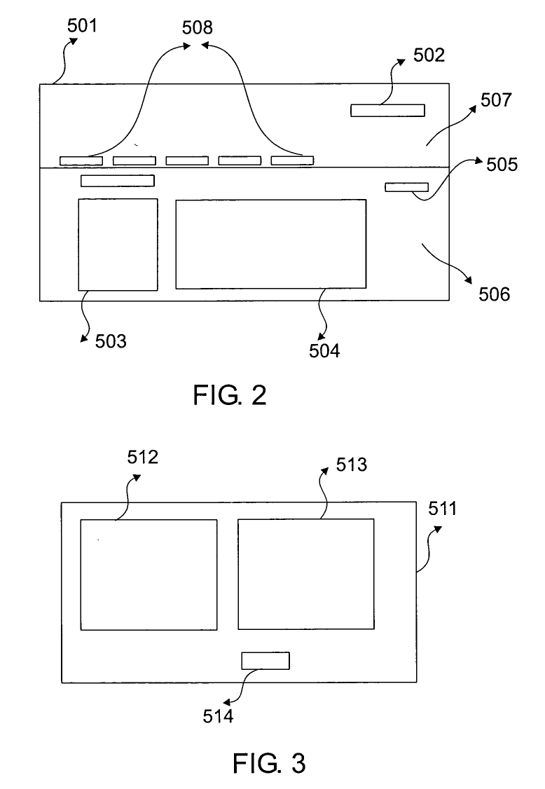

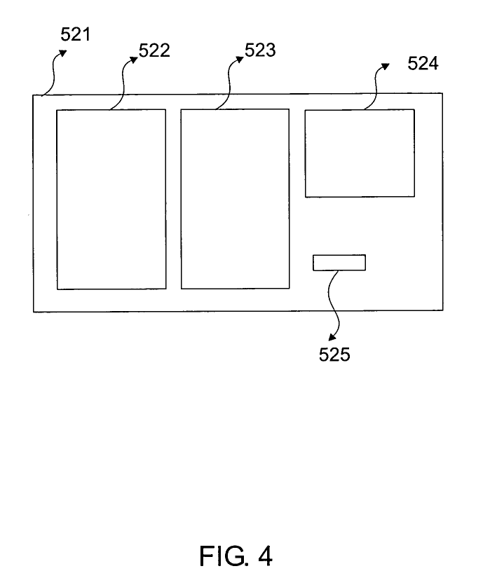

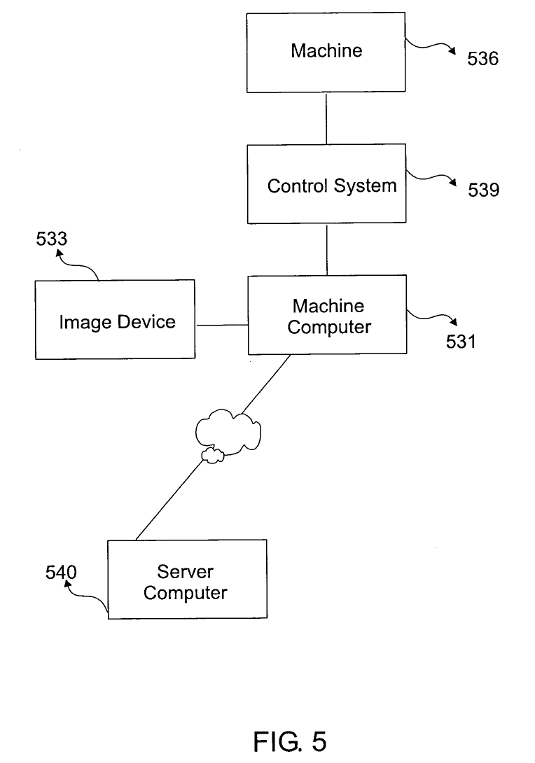

The preferred embodiment of the present invention will be described hereinafter in accordance with FIG. 1, FIG. 2, FIG. 3, FIG. 4 and FIG. 5. Reference numbers of the same components are identical across all figures. It should be noted that those skilled in the art are able to practice the present invention without specific details.

Referring to the drawings FIG. 1, the image device 533 has a movable arm 534 which can bend to difference directions; a stand 535 of the image device 533 is a magnetic base which can form a magnetic relationship with the surface of the machine 536. A light 532 is mounted on top of the shield of the machine to brighten the environment for the image device 533. The image device 533 is attached on the surface of the machine 536 then connects to the machine computer 531. The image device 533 is focused on an object then sent the image signal to the machine computer when connect interface. The object may include the work piece 537, tool 538 and their surrounding area.

Referring to FIG. 2, the Navigator 501 is a GUI (graphics user interface) divided by two parts of the main window 507 and multiple windows 506. Difference categorize is located on difference window and is selected by tab 508 options. Program/Run is assigned to one of the tabs 508. Example of Program/Run tab is clicked; the functions and contents of Program/Run are displayed for command on multiple windows 506. Main window 507 displays all real time information relate to position that send from the measuring device via control system and the stage of tooling and stage of devices.

Referring to FIG. 3 of the window of the Image Capturing 511. The image device is coupled the Navigator 501 by clicking camera button 502 on the main window 507 (FIG. 2). The image is then continually display on the image container 512 until the image device is disconnected.

Image can be selected and captured by clicking the snap button 514. The captured image is temporary stored in memory and displayed on image container 513. Additional clicks of the snap button 514 will capture new image that will replace the previous image and display it's in the same location.

When the captured image has been determined to be used then points to the captured image of image container 513 by mouse, then presses down the button of the mouse. Thereon directly dragged and dropped the captured image to the image container 503 of the Program/Run of the Navigator 501. When the captured image is dragged into the image container 503, an index number for the captured image is automatic generated. When the file is saved, all the images are packaged into the one file with existing data.

The window of Program/Run (FIG. 2) has a set of commands for the select and input information at command container 504 to program the job ordering by the user. The image container 503 is located beside of the command container 504. The captured images are the illustration of the program events for following the standardized operation.

Alternatively, image file that is stored in machine computer in a image file format can be imported to the image container 503 of the Navigator 501 without the need of directly capturing image from image device 533 to the Image Capturing 511. To perform this operation, double clicked the image container 503 of the Navigator 501 by the mouse, then a dialogue container of Select Picture 521 is displayed (refer to FIG. 4). Select the right path that is stored the desired image from directory box 522, and then click the file name from file name box 523. The image of selected file is displayed on the image container 524. Click the OK button 525 to confirm the selection. The Select Picture 521 is then closed and the selected image is imported to the image container 503 of Navigator 501.

Refer to FIG. 5 of the flow chart of the operation of signal machine computer and server computer. During the programmed job, a listing of the order of events including the accompanying illustration is displayed on the monitor. Thereon, clicks on the camera button 502 on the main window 507 of the Navigator 501 will connect to the image device 533, then the image is then transmitted for monitoring.

Meanwhile, the Navigator 501 automatically detects and connects to the server computer 540 via network. In case the server computer 540 is power off or the network is unplugged, the Navigator 501 will automatically attempt to establish a connection every 10 seconds.

When the machine computer and the server computer are connected, the server interface is receiving real time information that is sent from the Navigator 501, including current images that are sent from Image Capturing 511 then displayed on the server computer. The real time information may contain positioning values, machine information, captured image and voice warning. To control the operation from the server computer, buttons that are clicked by the mouse on the server interface cause commands to be sent to the machine computer. The machine computer relays the information to the control system to process the command.

It should be apparent that the preceding description illustrates the current invention in one embodiment only and the invention is not restricted to the preferred embodiment. It should also be evident to those skilled in that art that variations and modifications of the preferred embodiment are possible without departing from the spirit and scope of the design. Therefore, these claims shall cover any such variations and modifications that encompass the true scope and spirit of the invention.

1. An illustration system for capturing images to provide a standardized procedure for production using a computer-controlled machine, comprising of:
an image capturing software which means a program integrated on the navigator software, said program provides a graphic user interface on the monitor of a machine computer, said image capturing software contains different dialogue boxes to display images;
a navigator software which means a program executed by said machine computer, said program provides a graphics user interface on said monitor on said machine computer;
an image device for transmitting image information to said image capturing interface for display on said monitor on said machine computer by connecting to said navigator software;
a control system means a device that communicate between said computer-controlled machine and said navigator software of said machine computer.

2. The illustration system according to claim 1 wherein said image capturing software connects to said image device via said navigator software which is able to:
receive, continuously, images and then display them on dialogue box 1, which provides a monitoring of motion activity;
display captured images on the dialogue box 2 by clicking on a snap button to capture an image from said dialogue box 1;
accept additional clicks on said snap button to capture new images which replace the previous images and are displayed on said dialogue box 2;
point to said captured image on said dialogue box 2 then pressing down the mouse button of said machine computer to drag and drop said captured image to the dialogue box 3 of said navigator software.

3. The illustration system according to claim 1 wherein said navigator software means said program of:
integrating with said image capturing software;
linking with server interface via a network;
receiving/outputting information from/to said control system.

4. The illustration system according to claim 1 wherein said navigator software is able to:
receive captured image that is dragged from said image capturing interface as a part of program event that is displayed on said dialogue box 3 of said navigator software;
importing an image file from storage with an image file format then is displayed in said dialogue box 3 as a part of a program event;
program a list of the ordered events with a set of program commands that programmed from the user;
run a program event with images, said program events is programmed by the user;

5. The illustration system according to claim 4 wherein said program event means utilizing a set of program commands to ordering a list of operating on said computer-controlled machine, which means programmed job.

6. The illustration system according to claim 3 wherein said server interface means said program provides a graphic user interface on the monitor of the server computer to monitoring and control said computer-controlled machine operation via a network, comprising of steps:
(a) said image device is connected to said image capturing software through said navigator software to transmit image to said dialogue box 1 of said motion activity;
(b) said navigator software running said programmed job which automatically connects to said server computer, if said server computer is powered off or said network is unplugged, then said navigator software automatically detects the connection on every pre-set time frame until a connection is established;
(c) said machine computer and said server computer are connected and information is transmitted from said navigator software to the server computer; said information means positioning values, machine information, said captured images and voice warnings.
(d) said machine computer and said server computer is connected, said motion activity is transmitted from said image capturing software;
(e) controlling of computer-controlled machine by clicking on a command button on said server interface that sends a signal to said machine computer then to the control system.

7. The illustration system according to claim 6 wherein said server computer means the ability to establish connections to one or more machine computers which can accept information for one or more computers. This includes the ability to monitor and control one or more machine computers remotely via a network.

8. The illustration system according to claim 6 (c) said voice warning comprising of:
text information that is sent by said machine computer to process the command;
any value of labelled devices that reaches the threshold value, said machine computer sends a voice warning.

9. The illustration system according to claim 1 wherein said image device means a digital camera with a housing that includes moveable arm that can bend and turn in different directions and stand with a permanent magnetic base which can form a magnetic relationship with the surface of said computer-controlled machine.

10. The illustration system according to claim 1 wherein said control system having at least of one pair of MCUs (micro control units) for receiving position signal from measuring device and outputting the signal to the motor control movement on one axis. A PLD (programmable logic device) organizes all imputing and outputting signals and commands from/to said MCUs, said navigator software, said computer-controlled machine and said machine computer.

11. The illustration system according to claim 9 wherein said one axis means one direction either of longitude, latitude or altitude of relative to the machine movement.
